(19) United States
(12) Patent Application Publication
(10) Pub. No.: US 2004/0255325 A1
(43) Pub. Date: Dec. 16, 2004

(54) Information retrieval/reproduction apparatus and information displaying method

(76) Inventors: Maki Furui, Tokyo (JP); Isshu Nakajima, Fuchu (JP); Takashi Yoshimaru, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/849,246

(22) Filed: May 20, 2004

(30) Foreign Application Priority Data
Jun. 12, 2003 (JP) 2003-167260

(51) Int. Cl. H04N 7/173; G06F 13/00; H04N 5/445; G06F 3/00; H04N 7/16; H04N 7/08

(52) U.S. Cl. 725/61; 725/86; 725/87; 725/39; 725/38

(57) ABSTRACT

An information displaying method of an information retrieval/reproduction apparatus for operating a retrieval screen of a display device by a remote control device displays on one screen a content display area for displaying content in a list form and first and second retrieval areas for displaying retrieval items of a high order hierarchical layer of the content, changes in the first and second retrieval areas a display content of a retrieval area of a low order layer in accordance with the selection item selected through the operation of the remote operation device, selects in the content display area a plurality of contents through the operation of the remote control device and shits the content to a next decision operation.

### INCORPORATION BY REFERENCE

The present application claims priority from Japanese application JP2003-167260 filed on Jun. 12, 2003, the content of which is hereby incorporated by reference into this application.

### BACKGROUND OF THE INVENTION

This invention relates to an information retrieval/reproduction apparatus capable of easily extracting programs of television receivers and various kinds of contents stored in a recording/reproduction apparatus and its displaying method.

As broadcasting satellites, communication satellites and cable television have become wide spread in recent years, digital broadcasting services capable of receiving digitalized video information and program information have become wide spread, too. A system that can easily select a desired channel from a large number of channels has been required in such services. To satisfy the requirement, this system employs an electronic program guide called “EPG (Electronic Program Guide)”, reproduces a television program list electronically processed by a home television from a channel number, a broadcasting time of a program, a program name, a program content, the cast, and so forth, that are retrieved, retrieves an arbitrary program from the television program list and watches the program on the television.

Examples of such a system are described in JP-A-07-240881, JP-A-11-220675, and JP-A-2001-136454.

Owing to recent development of video recording technologies, on the other hand, it has become now possible to record large quantities of video information in HDD (hard disk drive) and DVD (digital versatile disk).

To accomplish a large number of functions, television receivers of the prior art technologies have a large number of menu screens and setting screens and conduct arbitrary retrieval by using a plurality of operation steps through a remote controller having a large number of function keys.

To accomplish various functions with a smaller number of screens and by use of a simpler remote controller, the prior art examples described above propose to pick up information of specific programs on the basis of predetermined information set in advance and to display them intensively on one screen of a display device.

### SUMMARY OF THE INVENTION

Though the prior art examples described above can grasp various information on one screen, selection and decision of the retrieval item must be repeated. Particularly when the number of information to be picked up becomes greater and the number of retrieval items increases, the number of times of repetition of selection and decision becomes greater. Because each item is handled in an equivalent display space in the prior art examples, recognition performance is yet left to be improved.

It is therefore an object of the invention to provide an information retrieval/reproduction apparatus capable of easily retrieving information and having high recognition performance, and a displaying method of this apparatus.

To accomplish this object, the invention provides an information retrieval/reproduction apparatus including a display device for retrieving content and displaying reproduction information; a control device for controlling retrieval and display of the reproduction information by the display device; and a remote operation device for instructing a display operation of the display device to the control device; wherein the control device displays, on one screen of the display device, a content display area for displaying a plurality of image information in a list form and first and second retrieval item areas for displaying retrieval items of a high order hierarchical layer of the content displayed in the content display area; the remote operation device includes a selection operation portion having selection keys for selecting the selection items of the first and second retrieval item areas, a content selection key for selecting the content of the content display area and a content operation portion for conducting a decision operation of the selected content; and the control device changes the selected item or content displayed in the area of a lower order hierarchical layer to the content selected by the selection keys by the operation of the selection operation portion and shifts an operation to a predetermined decision operation set in advance for the content selected by the content selection key and decided by the enter key.

The invention provides also a displaying method of an information retrieval/reproduction apparatus including a display device for retrieving content and displaying reproduction information; a control device for controlling retrieval and display of the reproduction information by the display device; and a remote operation device for instructing a display operation of the display device to the control device; wherein the control device displays, on one screen, a content display area for displaying a plurality of image information in a list form and first and second retrieval item areas for displaying retrieval items of a high order hierarchical layer of the content displayed on the content display area, accepts an operation of selection keys so provided to the remote operation device as to correspond to the first and second retrieval item areas, conducts selection display of the selection items provided in the areas, changes the selection item or content displayed in the areas of a lower order hierarchical layer to the content selected by the selection keys to display the content so changed, accepts a key operation of content selection keys provided to the remote control device, conducts selection display of the content displayed on the content display area, accepts an operation of a enter key provided to the remote operation device and shifts the content selected and displayed on the content display area to a predetermined decision operation set in advance.

The invention further provides an information retrieval/reproduction apparatus including a display device for retrieving content and displaying reproduction information; a control device for controlling retrieval and display of the reproduction information by the display device; and a remote operation device for instructing a display operation of the display device to the control device; wherein the remote operation device includes a plurality of direct buttons for displaying each display screen by jumping a menu selection display, the plurality of direct buttons is colored in color classification, and the control device displays the display screen displayed by clicking of the direct button in a color corresponding to the color of the direct button.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic structural view of a television receiver according to an embodiment of the invention;

FIG. 2 is a block diagram of a main body of the television receiver according to the embodiment of the invention;

FIG. 3 is an appearance view of the television receiver according to the embodiment of the invention;

FIG. 4 is a screen transition view for explaining a display screen of a menu screen and a first hierarchical layer of lower layers of the television receiver according to the embodiment of the invention;

FIG. 5 is a tree structural view of the screen transition of the television receiver according to the embodiment of the invention;

FIG. 6 is a schematic view of a program display screen of the television receiver according to the embodiment of the invention;

FIG. 7 is a schematic view of a program display screen displaying a functional window of the television receiver according to the embodiment of the invention;

FIG. 8 is a schematic view of a program reservation screen for reserving a program in the television receiver according to the embodiment of the invention; and

FIG. 9 is a schematic view of a cast registration window of the television receiver according to the embodiment of the invention.

### DESCRIPTION OF THE EMBODIMENTS

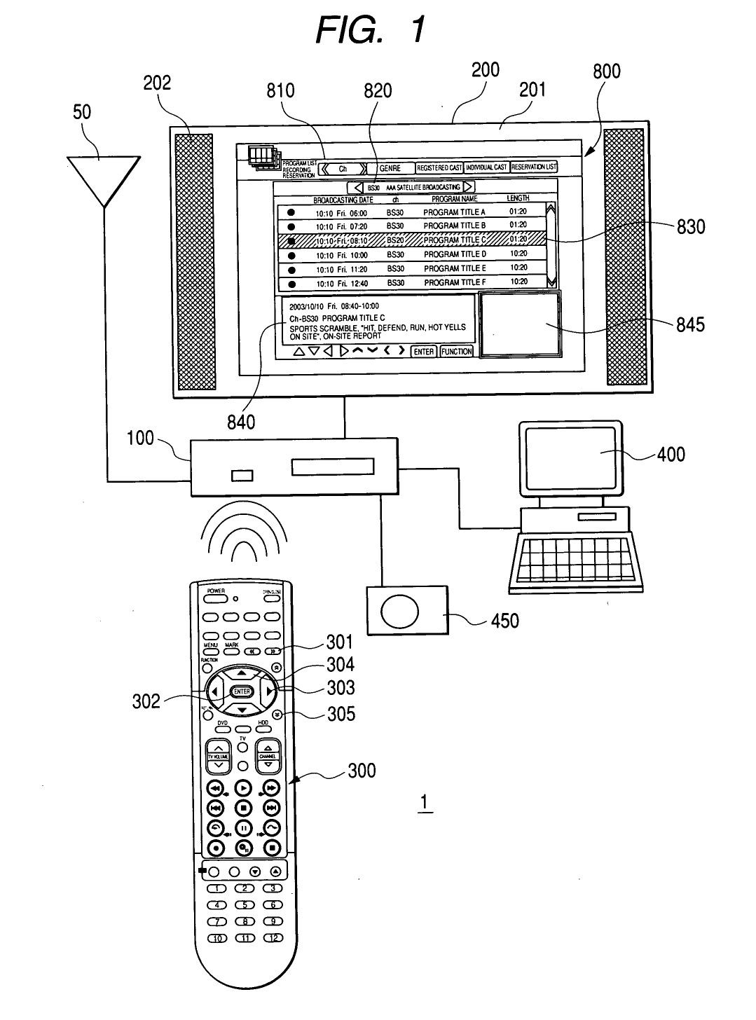

An information retrieval/reproduction apparatus and an information displaying method according to the invention will be hereinafter explained in detail with reference to FIGS. 1 to 9. Following embodiments represent an application of the invention to a television receiver having a large capacity storage device.

A schematic construction of this television receiver 1 will be explained first with reference to FIG. 1. FIG. 1 is a schematic structural view of the television receiver according to this embodiment.

Referring to FIG. 1, the television receiver denoted by reference numeral 1 includes a main body 100, a monitor 200 and a remote controller 300. The main body 100 has built-in television tuner and large-capacity storage device and constitutes the core of the television receiver 100. The monitor 200 is connected to the main body 100 through a cable and displays an image generated by the main body 100 on a display device 201. In this embodiment, speakers 202 are fitted to both sides of the display device 201 provided to the monitor 200. However, this configuration is in no way restrictive and television receivers having separate speakers or having a built-in television tuner may also be used. The remote controller 300 transmits operation signals to an infrared ray reception part, not shown, of the main body 100 through infrared ray signals and can collectively operate the television receiver 1.

When an antenna 50 is connected to the main body 100 through a cable, the television receiver 1 can receive ordinary ground wave broadcasting. When a satellite broadcasting antenna is connected, the television receiver 1 can receive satellite broadcasting. Furthermore, cable television can be connected, too. In this embodiment, the television receiver 1 has a mechanism adaptive to digital television broadcasting. Therefore, the television receiver 1 can receive various kinds of information such as program information (EPG) through these broadcastings besides the television image signals, can store them in the storage device and can make various kinds of retrieval from the information.

In this embodiment, the main body 100 can further be connected to a personal computer 400 and to a digital camera 450 having a built-in image storage device through a USB terminal. In consequence, the data stored in the large-capacity storage device of the main body 100 can be read out from the personal computer 400. When the digital camera 450 is easily connected to the USB terminal, the image stored in the image storage device can be displayed on the monitor 200.

It is one of the characterizing features of this embodiment that it employs an information displaying method that can retrieve easily and with high recognition performance those content information stored in broadcasting programs and in the large-capacity storage device and can extract a desired content. The monitor 200 shown in FIG. 1 displays a representative example of a program display screen 800 utilized for this information retrieving method.

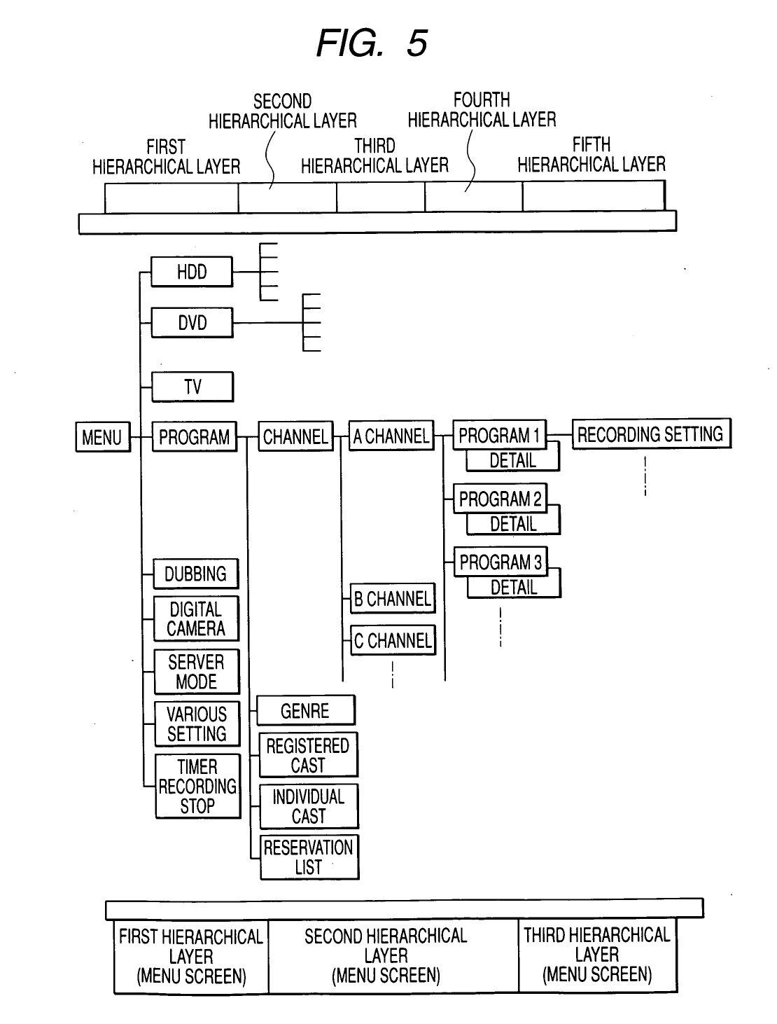

In this embodiment, the overall operations inclusive of information retrieval are constituted by a tree structure as shown in FIG. 5 and information retrieval and various kinds of setting can be made through this tree structure. In this embodiment, second to fourth hierarchical layers necessary for information retrieval are displayed on one screen (program display screen 800) shown in FIG. 1 so as to eliminate switching of screens during retrieval and to improve operation and recognition performances.

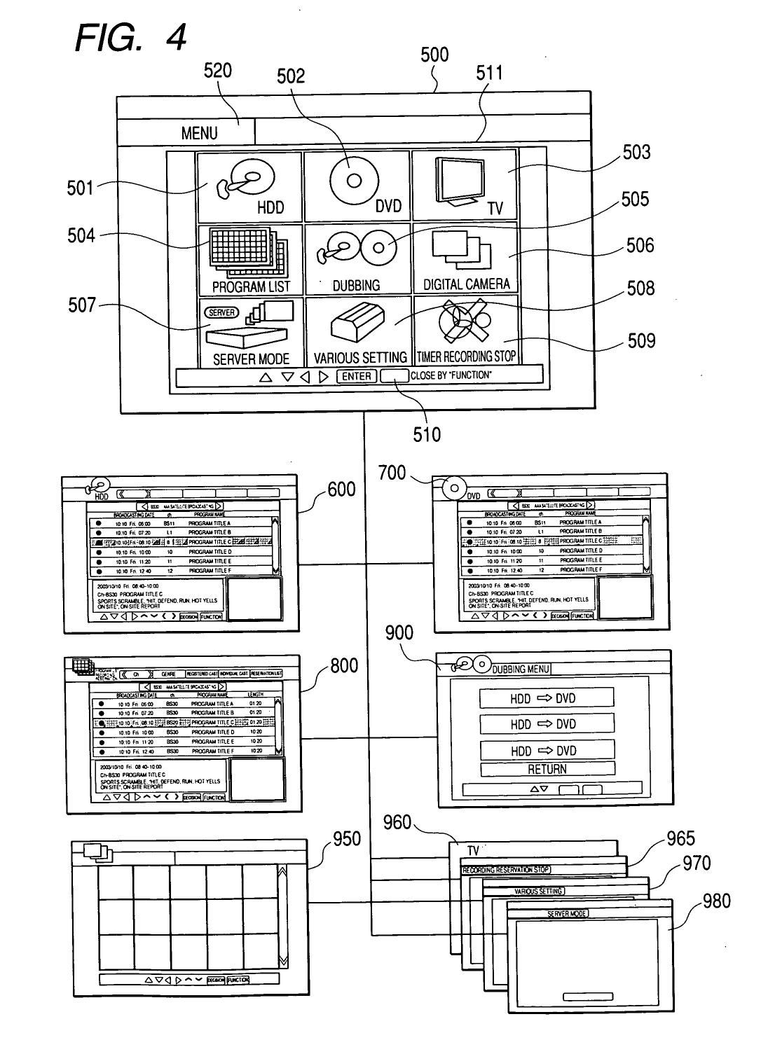

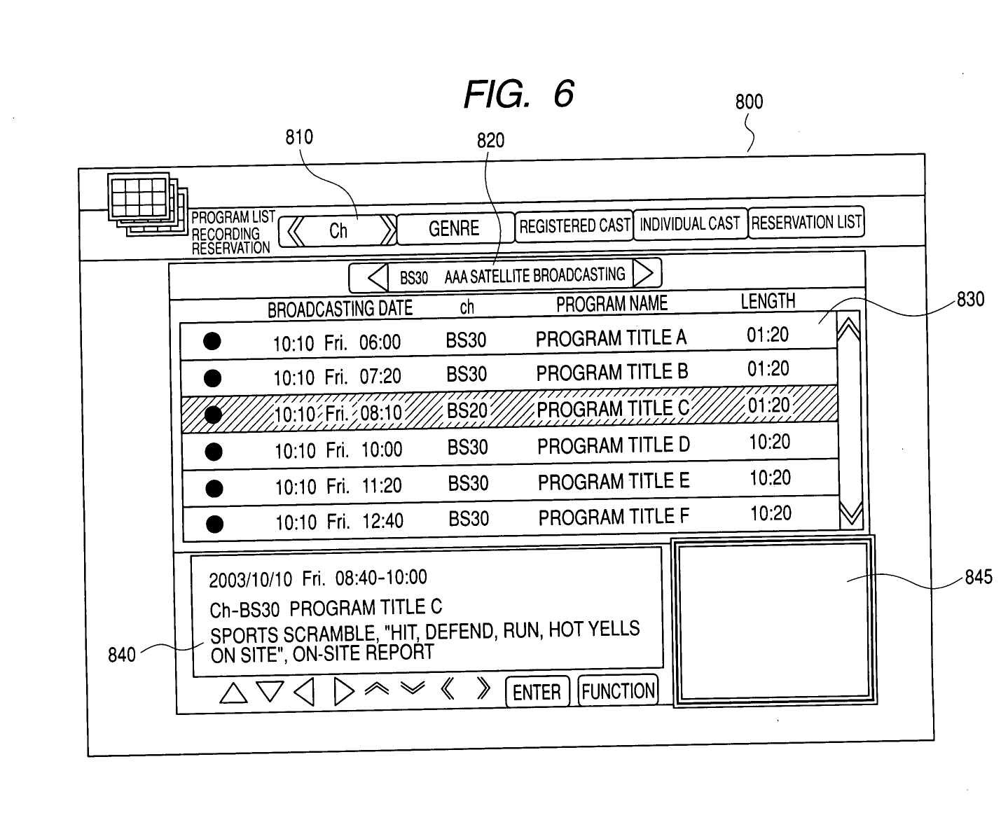

In this embodiment, a belt-like second retrieval item area 810 is disposed at the uppermost part of the display screen 800, a belt-like third retrieval item area 820 is disposed below the former and a content selection area 830 of selection objects is disposed below the third retrieval item area 820. For example, the display example shown in FIG. 1 represents the program display screen 800 (refer to FIG. 6 for detail) of a “program list” selected from a menu screen 500 (see FIG. 4) for selecting the first hierarchical layer. In this case, the second retrieval item area 810 displays the first retrieval items such as “Ch” (retrieve by channel), “genre” (retrieve by genre (category)), “cast” (retrieve by registered cast), etc and the third retrieval item area 820 displays the channel to be selected such as BS30. The content selection area 830 displays the broadcasting program list in the list for.

On the other hand, the remote controller 300 includes a pair of right and left scroll keys 301, and a pair of right and left scroll keys 303 and a pair of up and down scroll keys 304 that are arranged in a crisscross form on the right and left sides and above and below an enter key 302, respectively. The remote controller 300 further includes a pair of screen scroll keys 305 for moving up and down the broadcasting program list displayed in the lift form in the content selection area 830.

This embodiment can select the items of the second retrieval item area 810 through the right and left scroll keys 301. When this selection is made, the selection items of the third retrieval item area 820 are changed and with this change, a content satisfying an AND condition of the selection item of the program list of the content selection area 830 displayed and selected in the second retrieval item area 810 and the third retrieval item area 820 is displayed in the list form. When CH is selected in the second retrieval item area 810, for example, a channel of initial setting can be displayed in the third retrieval item area 820 and the broadcasting program of the channel of initial setting can be displayed in the content selection area 830.

The selection items of the third retrieval item area 820 can be selected by using the right and left scroll keys 303. When this selection is made, the list of the contents of the content selection area 830 is changed to the list of-the selected item. In FIG. 1, for example, the channel displayed in the third retrieval item area 820 can be changed. Consequently, the display content of the content selection area 830 is changed to the broadcasting program of the selected channel.

The content displayed in the content selection area 830 can be selected through the up and down scroll keys 304. The selected content is displayed in emphasis by changing a color or by encompassing it with a thick frame.

The content selection area 830 can also be scrolled up and down as a whole by using the screen scroll keys 305.

The content selected in the content selection area 830 can be shifted to a decision operation set in advance by using the enter key 302. For example, in this program display screen 800, the program of the selected content is displayed on the full screen of the display device 201.

As described above, in the second and third retrieval item areas 810 ad 820, the display content of the retrieval item area of the lower hierarchical layer or the content selection area 830 can be changed by one operation by operating the right and let scroll keys 301 and 303 without operating the enter key 302. Therefore, the number of operation steps of the operation keys can be decreased.

In the content selection area 830 for selecting the final content, on the other hand, the content to be decided can be decided by operating the enter key 302 after selection is made by operating the up and down scroll keys 304. Moreover, when the content is great, the screen can be switched by operating the screen scroll keys 305.

As described above, the selection/decision operation that has been made in the past by repeating selection and decision is made by one final decision operation in this embodiment and the number of times of operations can be decreased. Therefore, the selection/decision operation can be simplified and can be moreover conducted quickly.

The program display screen 800 in this embodiment includes a detail display area 840 and a sub-display screen 845 at a lower part of the screen.

The detail display area 840 displays detailed information of the selected content. Therefore, the decision operation can be made without switching the screen while an operator confirms the detail information.

The sub-display screen 845 displays the display content displayed before this retrieving operation such as the display content displayed on the display device 201 before the display of the menu screen 500. Therefore, the retrieving operation can be made while keeping the display content before the deciding operation.

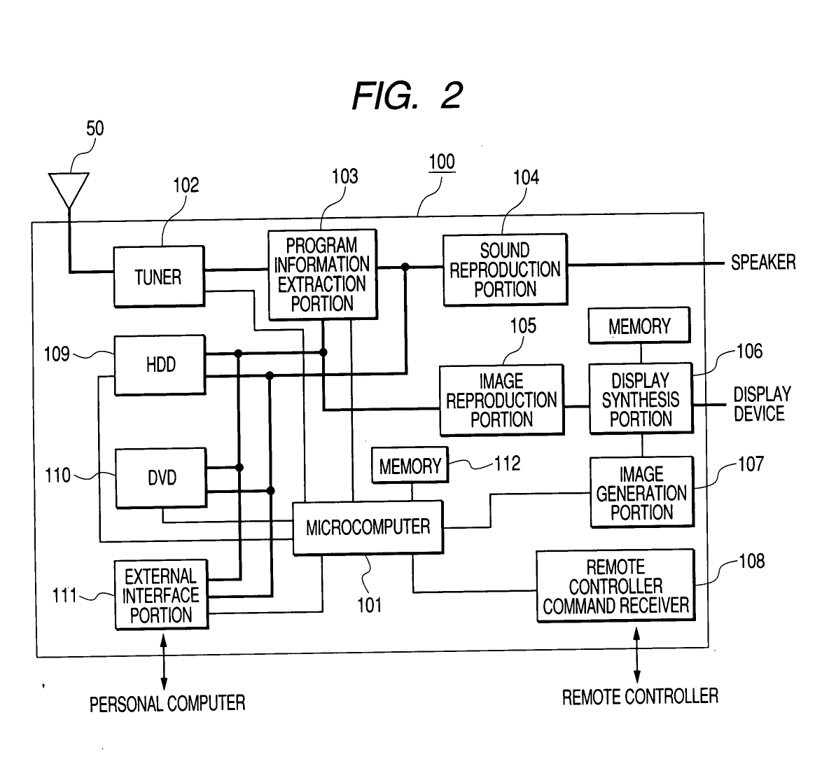

The information retrieving screen of the television receiver 1 according to this embodiment will be explained in further detail with reference to FIGS. 2 to 9.

First, internal devices inside the main body 100 will be explained with reference to FIG. 2. This drawing is a block diagram of the main body 100.

In this embodiment, a microcomputer 101 receives an operation instruction signal of the infrared rays from the remote controller 300 through a remote controller command receiver 108 and collectively controls the television receiver 1 on the basis of this operation instruction.

A tuner 102 is of a known type that can receive broadcasting waves containing electronic program guide information (EPG information) overlapped with the broadcasting waves. The electronic program guide information contains a program ID and a program table necessary for extracting a desired program from a stream in which a channel number, a broadcasting time of programs, program contents, the cast and a plurality of programs are multiplexed. The broadcasting waves may be any of the ground broadcasting waves, the satellite broadcasting waves and the cable broadcasting signals.

A program information extraction portion 103 separates the broadcasting waves received by the tuner 102 into EPG information and content information and outputs them to a sound reproduction portion 104 and an image reproduction portion 105. The sound reproduction portion 104 outputs the sound through the speakers 202. As for the image information, a display synthesizing portion 106 synthesizes the image signal from the image reproduction portion 105 and graphic data from a screen generating portion 107 and outputs the signal so synthesized to the monitor 200 described already.

This embodiment includes an HDD (hard disk drive) 109 and a DVD (digital versatile disk) 110 as the large-capacity storage device. The embodiment can reproduce the contents stored in these DVD 110 and HDD 109 and can moreover store the contents received through the broadcasting waves into the DVD 110 and the HDD 109. Dubbing can also be made between the DVD 110 and the HDD 109.

In this embodiment, the retrieval information can be simultaneously stored when the information is stored into the DVD 110 and the HDD 109. This embodiment conducts various kinds of retrievals from the retrieval information and the EPG information and can display the retrieved broadcasting wave or the content stored in the DVD 110 or the HDD 109 or can record or duplicate the content (inclusive of reservation program) of the broadcasting waves.

In this embodiment, an external interface portion 11 has a USB terminal. Therefore, other add-in storage devices can be connected to the information retrieval/reproduction apparatus. In the case of connection of a digital camera 450 having a built-in image memory device, for example, the image of the image memory device of the digital camera 450 can be reproduced or read out and can be stored into the HDD 109 or the DVD 110 under control of the microcomputer 101 by merely connecting the USB terminal to the digital camera 450 without removing a medium having a memory device from the digital camera 450 and reproducing the image by use of a readout apparatus as has been necessary in the prior art technologies.

In this embodiment, it is further possible to fit a connection interface with a personal computer 400 to the external interface portion 111 and to accommodate the connection interface inside the main body 100. Examples of the connection interface include a MODEM and a LAN board. When the LAN board is connected, collective control right of the main body 100 provided to the microcomputer 101 can be shifted to the personal computer 400. Since the HDD 109 and the DVD 110 of the main body 100 can freely be controlled in this way from the personal computer 400, the contents stored in the HDD 109 and the DVD 110 need not be loaded down every time to the personal computer 400.

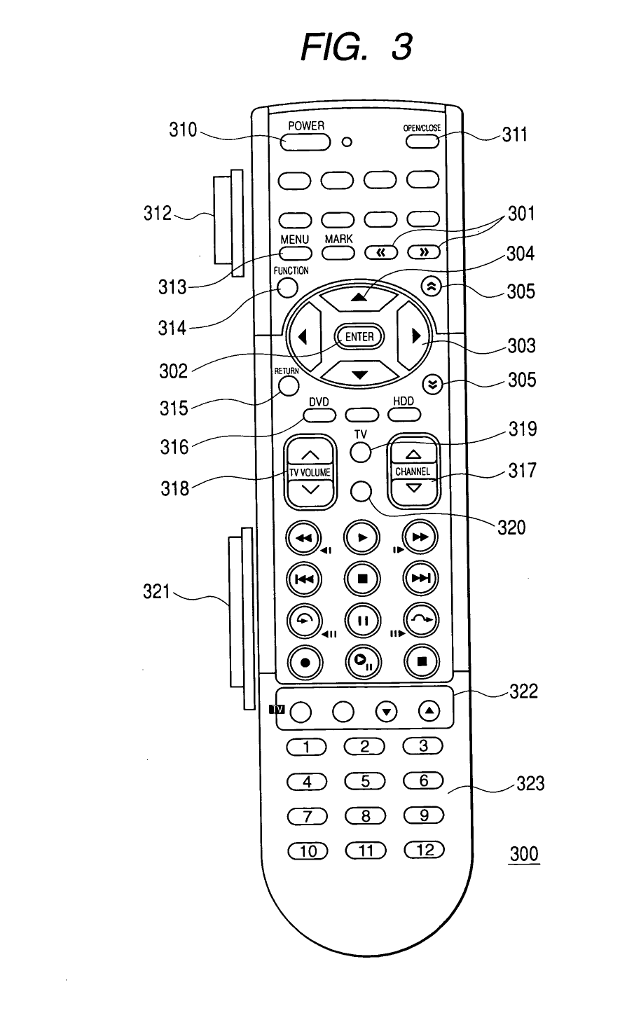

Next, the remote controller 300 will be explained with reference to FIG. 3. The drawing shows an operation panel of the remote controller. Referring to FIG. 3, the remote controller 300 has an infrared ray transmission portion, not shown, at one of the ends (at an upper part in the drawing) of a flat box-shaped main body in a longitudinal direction and a plurality of operation keys on the side of a broad surface of the main body.

In FIG. 3, reference numeral 310 denotes a power source key of the television receiver 1. Reference numeral 311 denotes an open/close key for a disk table of the DVD 110. Reference numeral 312 denotes a function key group. The pair of right and left keys 301 described already and a menu key 313 for displaying a menu screen 500 are arranged as members of the function key group. Reference numeral 314 denotes a function key. As will be described later, the function key 314 displays a window for executing a processing of the content selected in a content selection area 830. Reference numeral 315 denotes a return key for returning a processing screen to an original state. Reference numeral 316 denotes a direct key group that includes direct keys of DVD, program list and HDD that have high frequency of use in the menu screen 500. Among the direct keys, DVD is colored to green, the program list, to violet and HDD, to blue, for example, and the display screen displayed when each of these keys is selected is displayed in the color corresponding to the color of the direct key. When the direct key group 316 is operated, the next screen can be displayed while jumping the menu screen 500.

Reference numeral 317 denotes a station selection forward/back key. Reference numeral 318 denotes a volume key. Reference numeral 319 denotes a TV changeover key. Reference numeral 320 denotes a reservation list direct key. Reference numeral 321 denotes HDD/DVD recording/reproduction key group. Reference numeral 322 denotes an operation key group when the monitor 200 is used as other television receiver. Reference numeral 323 denotes a station selection key group of the tuner 102.

Next, the outline of various functions of the television receiver 1 according to this embodiment will be explained with reference to FIG. 4. The drawing is a screen transition view useful for explaining the menu screen 500 of this embodiment and the display screen of a first hierarchical layer below the menu screen 500.

In FIG. 4, this embodiment can conduct various kinds of operations and setting from the menu screen 500. When the menu key 313 of the remote controller 300 is operated, the microcomputer 101 calls the image from the memory 112 and displays it on the menu screen 500. The menu screen 500 has a title bar 520 at its uppermost part and displays that this screen is the menu screen. In this embodiment, each screen displays this title bar 520 at the upper part and displays the title of the screen.

The menu screen 500 has its lower part an operation key display portion 510 representing the keys that can be operated on the menu screen 500. The mark indicated on each key top of the remote controller 300 is disposed in this operation key display portion 510 so that the keys that can be operated at present can be known at a look. Because this operation key display portion 510 is provided at the lower part of each display screen, the keys that can be operated on each display screen can be known at a look in any of the display screens.

A first hierarchical layer selection area 511 as a lower layer of the menu screen 500 is arranged at the center of the menu screen 500. Nine selection items of the first hierarchical layer are prepared in this embodiment. Reference numeral 501 denotes a selection item for displaying an HDD display screen 600. Reference numeral 502 denotes a selection item for displaying a DVD display screen 700. Reference numeral 503 denotes a selection item for displaying a TV screen 960 on a full screen. Reference numeral 504 denotes a selection item for displaying the program display screen 800. Reference numeral 505 denotes a selection item for displaying a dubbing screen. Reference numeral 506 denotes a selection item for displaying a digital camera display screen 950. Reference numeral 507 denotes a selection item for displaying a server mode display screen 980. Reference numeral 508 denotes a selection item for displaying a setting display screen 970. Reference numeral 509 denotes a selection item for displaying a timer recording stop display screen 965. As described above, this embodiment has the direct keys of the DVD, the program list and the HDD that have high frequency of use among the direct key group 316 and when each direct key is operated, the microcomputer 101 displays each second hierarchical layer screen without displaying the menu screen 500.

The content stored in the HDD or the DVD can be retrieved and reproduced on the HDD display screen 600 or the DVD display screen 700. The content can be retrieved from the program list on the program display screen 800 and this broadcasting can be listened to or the retrieved content can be reserved for recording. Because the HDD display screen 600 and the DVD display screen 700 have the same screen layout as that of the program display screen 800 that will be hereinafter explained in detail, their detailed explanation will be omitted.

Dubbing from the HDD 109 to the DVD 110, re-recording from the HDD 109 to HDD 109 and dubbing from the DVD 110 to the HDD 109 can be selected on the dubbing display screen 900. Here, re-recording of the HDD 109 is a change of a capacity or an image quality size. The content stored in the digital camera 450 is subjected to thumb nail display in the grid form on the digital camera display screen 950 and is selected and displayed on the full screen, or various kinds of image processing can be executed.

When the selection item 507 of the menu screen 500 is selected and operated, the control right of the microcomputer 101 is transferred to the personal computer 400. Therefore, even when receiving the operation signal from the remote controller 300, the microcomputer 101 does not operate. For this reason, the operation key button of the enter key 302 is displayed on the server mode display screen 980 as the operation for taking back the control right to the microcomputer 101.

A plurality of selection items for conducting various kinds of setting is displayed in a frame form on the various setting display screen 970 and when selection is made, the operation setting screen of the lower layer can be displayed.

The timer recording stop display screen 965 is the one that stops reservation recording. In the prior art apparatuses for conduction reservation recording such as VTR and DVD, this reservation recording is preferentially processed. Therefore, the circuit arrangement is employed so as not to easily stop reservation recording once the operation mode shifts to reservation recording. In the prior art examples, reservation recording is stopped by operating the combination of a plurality of operation keys or operating a hidden key but when the operator forgets this operation, the operator has to take the trouble of referring to an instruction manual. To easily stop reservation recording without error, the menu screen 500 in this embodiment has the selection item 509 to stop reservation recording on the hierarchical layer screen. In this embodiment, the timer recording stop display screen 965 displays a recording stop button and a caution guidance to stop reservation recording.

Next, the construction of the screen transition in this embodiment will be explained with reference to FIG. 5. The drawing shows the tree structure of the screen transition in the embodiment. This embodiment employs a branch screen system of a tree structure in which a plurality of display screen branches from the menu screen 500 and display screens further branch from each of the branching display screens. FIG. 5 shows the structure of the screen transition of the tree structure. Typical screen transitions are shown at the center, the retrieval hierarchical layers are shown at the upper part of the drawing and the number of screens, at the lower part. To accomplish information retrieval that can be made easily and has high recognition performance, a contrivance is made particularly to the items of the HDD, the DVD and the program each having a large number of retrieval items.

The contrivance is that the second, third and fourth hierarchical layers as the retrieval items of information retrieval are retrieved on one retrieval screen of the second hierarchical layer. In this embodiment, the menu screen 500 as the first hierarchical layer screen is switched to the second hierarchical layer screen corresponding to the object and the display mode shifts from this second hierarchical layer screen to the third hierarchical layer screen for setting reproduction of the retrieved content and functions or for setting further functions.

The HDD and the DVD, in particular, that typically handle the program employ the screen transition described above because they have to set an arbitrary condition from the program list and the retrieved information, to extract the corresponding content and to reproduce or record the content or to correct the information.

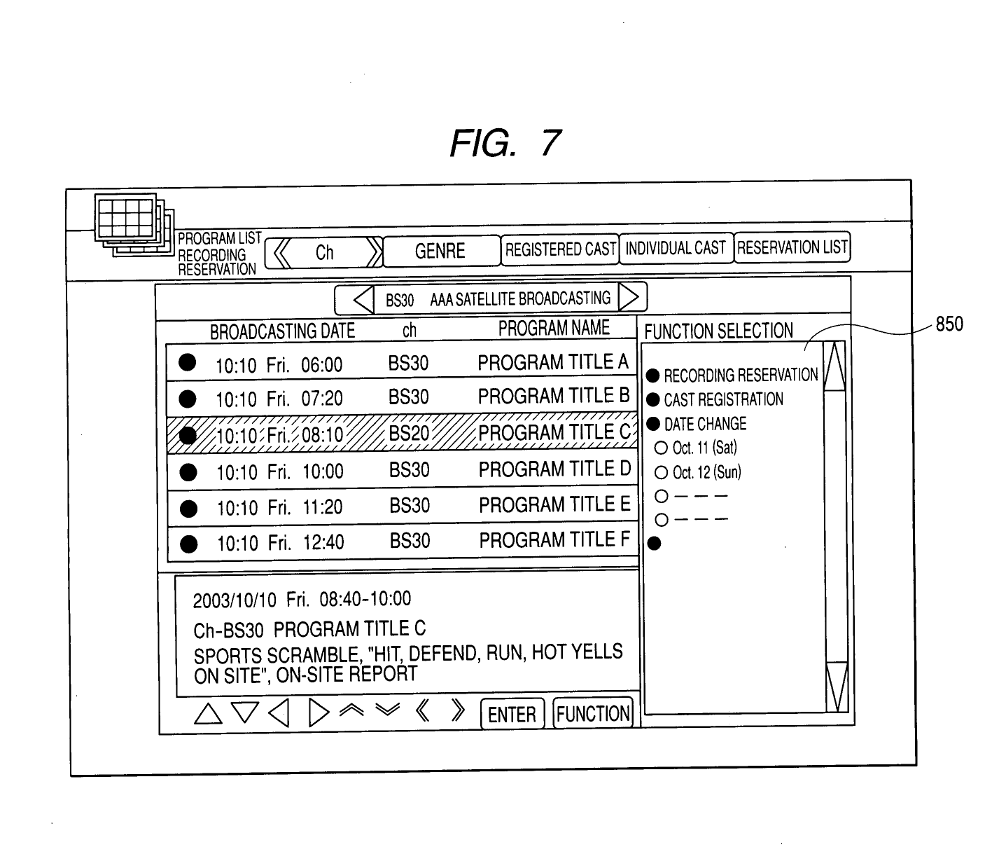

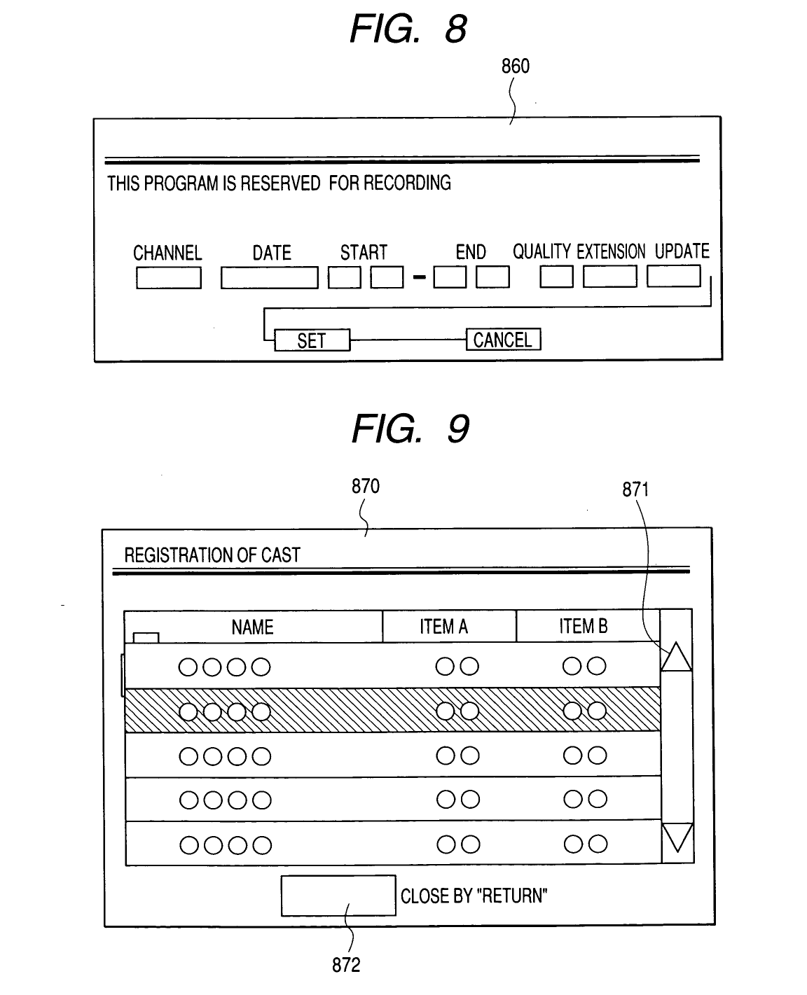

The screen transition in this embodiment will be explained about the program display screen 800 as a typical example having a large number of retrieval items with reference to FIGS. 3 and 6 to 9. FIG. 6 is a screen view of the program display screen 800. FIG. 7 is a screen view of the program display screen 800 displaying a function window. FIG. 8 is a screen view of a program reservation window for program reservation. FIG. 9 is a screen view of a cast registration window.

First of all, the microcomputer 101 stores the display state of the monitor 200 at previous turn-off of the power source in the memory and always monitors the operation signal of the power source 310 of the remote controller 300. Receiving the power ON signal, the microcomputer 101 retrieves the memory and reproduces the state of the monitor 200 at the end of the previous operation. When the television broadcasting is reproduced previously, the broadcasting wave received at present by the channel of this television broadcasting is received by the tuner 102 and is displayed on the monitor 200. This channel can be changed through the station forward/back key 317 or the station selection key group 323 of the remote controller 300. When the menu key 313 is operated under this state, the microcomputer 101 calls the menu screen 500 from the memory and displays it on the monitor 200. The menu screen 500 can be selected from one of the nine first hierarchical layers by operating the up and down scroll keys 304 and the right and left scroll keys 303 of the remote controller 300. When selected, the selection item of the first hierarchical layer is displayed in emphasis by thick frame display or by changing the display color. When receiving the operation of the enter key 302 of the remote controller 300, the microcomputer 101 displays the second hierarchical layer screen as the lower hierarchical layer of the selection item of the first hierarchical layer displayed in emphasis on the monitor 200. Receiving the operation signal of the function key 314, the microcomputer 101 closes the menu screen 500 and returns the display state to the original display state. The explanation will be given hereby on the assumption that the program list 504 is selected. Incidentally, the screen may be shifted through the operation of the direct key group 316 as described above.

When the program list 504 is selected, the microcomputer 101 displays the program display screen 800 shown in FIG. 6 on the monitor 200. This display screen is displayed in the color corresponding to the color of the program list key of the direct key 316 such as violet. When the selection item of the second hierarchical layer of the program display screen 800 is selected in this embodiment, the kind of the selection items of the third hierarchical layer can be selected. In this embodiment, the second hierarchical layer of the program display screen is set to the channel “Ch” for setting the channel of the broadcasting station, the “genre” (category) or setting the genre of the drama, the music, etc, the “cast” for setting the registered cast contained in the EPG information and the retrieval information of the DVD, etc, the individual cast for setting the individual cast and the reservation list for extracting the content that is registered for reservation.

The selection items of the second hierarchical layer are displayed in the second retrieval item area 810 and are selected by the pair of the right and left scroll keys 301 of the remote controller 300. Receiving the operation signals of the pair of the right and left scroll keys 301, the microcomputer 101 moves bracket marks and displays the item selected by the parenthesis mark moved. FIG. 6 shows the case where the channel “Ch” is selected.

In this embodiment, broadcasting stations of an A channel and a B channel are set as the selection items of the third hierarchical layer of the channel “Ch”. The selection items of the third hierarchical layer are displayed in the third retrieval item area 820. Because a plurality of channels exists in this embodiment, only the selected channel is displayed in the third retrieval item area 820 and arrows are put on the right and left to represent that other selection items exist. Receiving the operation signal of the pair of the right and left scroll keys 303 of the remote controller 300, the microcomputer 101 changes the display content of the third retrieval item area 820 in such a manner as to correspond to the moving direction operated and sets the display content to the third selection condition.

As described above, the microcomputer 101 changes the display content of the third retrieval item area 820 in accordance with the operation of the pair of the right and left scroll keys 301 for operating the second hierarchical layer and further changes independently the display content in accordance with the pair of the right and left scroll keys 303 for operating the third hierarchical layer. Incidentally, when the display content changes with the operation of the right and left scroll keys 301, the third hierarchical layer may well display the initial value set in advance but when the content of previous setting is stored in the memory, the number of operation steps can be decreased in accordance with the peculiar way of operation of the operator.

The content that is finally retrieved as the fourth hierarchical layer is set to this program display screen 800. In this embodiment, the microcomputer 101 extracts the content satisfying the second and third selection conditions from the EPG information stored in the memory 112 and displays the extraction result in the list form on the content selection area 830. The list displays a mark representing the kind of the content, the broadcasting date and time, the channel, the program name and the length in one row and this content is listed up and below.

Receiving the operation signal of the pair of up and down scroll keys 304, the microcomputer 101 moves the emphasis display representing the section in the operated direction. Receiving the operation signal of the pair of the screen scroll keys 305, the microcomputer 101 scrolls the up and down the content selection area 803 as a whole. The up and down scroll bar is displayed on one of the sides of the content selection area 830 to represent the direction in which the screen can be scrolled.

The microcomputer 101 displays in the detail display area 840 the detailed information of the content selected and displayed in emphasis in the content selection area 830. Therefore, the operator can select the content to be decided while looking up this detailed information. In this embodiment, the shift to the next display screen does not occur unless the enter key 302 is operated. Therefore, the operator selects the content to be selected and decided by operating the three pairs of scroll keys and then operates the enter key 302 of the remote controller 300 while confirming the detail screen and can shift the screen to the next step.

Since the display screen prior to the menu screen 500 is displayed on the sub-screen 845 in this program display screen 800, the operator can select the program to be next watched while watching other broadcasting program. Furthermore, since the operation key of the remote controller 300 that can be operated on the display screen is displayed in the operation key display portion 510, the erroneous operation and bewilderment of the operation by the operator can be reduced.

In the program display screen 800 according to the embodiment, the title of the first hierarchical layer is displayed on one of the sides of the uppermost part, the selection item of the second hierarchical layer as the lower layer of the first hierarchical layer is displayed below the first hierarchical layer, the selection item of the third hierarchical layer is displayed below the second hierarchical layer and the content of the fourth hierarchical layer to be finally selected is displayed below the third hierarchical layer. Since the hierarchical structure is arranged from above to below, the tree structure can be recognized visually more easily. Furthermore, recognition performance is high because the content to be finally selected is displayed in the list form on the content selection area 830 having a large space while other high order hierarchical layers are displayed as one row display in smaller display.

The great feature of the embodiment among others is that the enter key 302 needs only one operation and the selection keys (scroll keys) of each high order hierarchical layer before this decision operation serially switches the display of the low order hierarchical layers. Therefore, this embodiment can reduce the number of the decision operations that have required in the past the same number of times of operations as the number of the high order hierarchical layers to only one and can drastically reduce the number of times of operations.

Because the display screen is displayed in the color in match with the color of the direct key, the operator can easily recognize to which menu (any of DVD, program list and HDD) the screen displayed at present corresponds.

Next, the function key 314 will be explained. This embodiment has the great feature in that the third hierarchical layer screen of the retrieval screen requiring the information retrieval such as the HDD, the DVD and the program list uses the window system. In this embodiment, the content selected by the content selection area 830 is displayed in full screen display on the display device 201 when the enter key 302 is operated on the program display screen 800.

Under this state, however, the microcomputer 101 displays the function window 850 having a function capable of processing the content under selection and shown in FIG. 7 when it receives the operation signal of the function key 314 of the remote controller 300. The function window 850 is displayed at an embedded position on one of the sides of the content selection area 830. The selection item displayed in the list form in the function window is selected by operating the up and down scroll keys 304 and the screen scroll keys 305 and the current function shifts to the selected function by the enter key 302.

When reservation recording is selected in FIG. 7, for example, the microcomputer 101 further displays the program reservation window 860 in superposition with the program display screen 800. In this program reservation window 860, the values of the selected content are displayed in the channel, the date, the start (time) and the end (time) and the initial values are set to the quality, extension and updating. The respective values can be selected by operating the right and left scroll keys 303 and can be changed by operating the up and down scroll keys 304. When setting is selected and the enter key 302 is operated, the microcomputer 101 records this reservation information to the memory and starts recording the information to the HDD 109 when the predetermined time is reached.

On the other hand, FIG. 9 shows the cast registration window 870 when the cast registration is selected and displayed from the function window 850. In this registration of the cast, the cast of the selected content contained in the EPG information is displayed in the list form. The cast is selected by operating the up and down scroll keys 304 and the screen scroll keys 305 and is added to the individual cast list stored in the memory by operating the enter key 302. Here, reference numeral 871 denotes a screen scroll display portion and reference numeral 872 denotes a return button display that is finished by the back key 315 of the remote controller.

As described above, the function setting screen as the third hierarchical layer screen is displayed in the window form in superposition with the retrieval screen of the second hierarchical layer in this embodiment. Therefore, bewilderment of the operator due to switching of the screen can be reduced and both of the operation performance and the recognition performance can be improved.

Though the embodiment of the program display screen has been explained above, it is possible to conduct the screen transition in the display screens of the HDD and the DVD and to obtain the similar functions and effects.

A character input window, not shown, can also be displayed as a window selected from the function window 850. A plurality of Japanese character (kana) keys and alphabetic characters is displayed on the character input window. Characters are inputted by using them into a selected character display area, or the characters inputted to the selected character display area are converted to Chinese (kanji) characters and after edition is made once inside the selected character display area, the character string can be inputted to the second hierarchical layer screen.

Though the menu screen 500 is displayed on the first hierarchical layer in the embodiment given above, a tree structure in which the menu screen is omitted and each hierarchical layer is graded up by one may be used, too.

The present invention can provide an information retrieval/reproduction apparatus capable of easy information retrieval and having high recognition performance and a displaying method for the information retrieval/reproduction apparatus.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An information retrieval/reproduction apparatus including:
a display device for retrieving a content and displaying reproduction information;
a control device for controlling retrieval and display of the reproduction information by said display device; and
a remote operation device for instructing a display operation of said display device to said control device; wherein:
said control device displays, on one screen of said display device, a content display area for displaying a plurality of image information in a list form and first and second retrieval item areas for displaying retrieval items of a high order hierarchical layer of the content displayed by said content display area;
said remote operation device includes a selection operation portion having selection keys for selecting the selection items of the first and second retrieval item areas, a content selection key for selecting the content of said content display area and a content operation portion for conducting a decision operation of the selected content; and
said control device changes the selected item or content displayed in said area of a lower order hierarchical layer to the content selected by said selection key by the operation of said selection operation portion and shits an operation to a predetermined decision operation set in advance for the content selected by said content selection key and decided by said enter key.

2. A displaying method of an information retrieval/reproduction apparatus including a display device for retrieving content and displaying reproduction information; a control device for controlling retrieval and display of the reproduction information by said display device; and a remote operation device for instructing a display operation of said display device to said control device; wherein:
said control device displays, on one screen, a content display area for displaying a plurality of image information in a list form and first and second retrieval item areas for displaying retrieval items of a high order hierarchical layer of the content displayed on said content display area; accepts an operation of selection keys so provided to said remote operation device as to correspond to said first and second retrieval item areas; conducts selection display of selection items disposed in said areas and changes the selection item or content displayed on said areas of a lower hierarchical layer to the content selected by said selection keys and displays the content so changed; accepts an operation of content selection keys provided to said remote operation device and selects and displays the content displayed on said content display area; and accepts a key operation of a enter key provided to said remote operation device and shifts the content selected and displayed on said content display area to a predetermined decision operation set in advance.

3. An information retrieval/reproduction apparatus including:
a display device for retrieving a content and displaying reproduction information;
a control device for controlling retrieval and display of the reproduction information by said display device; and
a remote operation device for instructing a display operation of said display device to said control device;
wherein:
said remote operation device includes a plurality of direct buttons for displaying each display screen by jumping a menu selection display, said plurality of direct buttons are colored in color classification, and said control device displays the display screen displayed by push-down of said direct button in a color corresponding to the color of said direct button.
